(19) United States
(12) Patent Application Publication
(10) Pub. No.: US 2011/0085870 A1
(43) Pub. Date: Apr. 14, 2011

(54) Tool support arrangement having at least one externally adjustable shaft

(76) Inventors: Günther Zimmer, Rheinau (DE); Martin Zimmer, Rheinau (DE)

(21) Appl. No.: 12/924,624

(22) Filed: Sep. 30, 2010

Related U.S. Application Data
(63) Continuation-in-part of application No. PCT/DE2009/000429, filed on Apr. 2, 2009.

(30) Foreign Application Priority Data
Apr. 2, 2009 (DE) 10 2008 017 117.4

(51) Int. Cl. B23Q 1/54

(52) U.S. Cl. 409/204

(57) ABSTRACT

In a tool pivot unit with a pivot head which is disposed in a housing and in which a drivable tool holder is supported so as to be rotatable by at least 100 degrees about a pivot axis which extends transverse to the movement direction of the machine tool carriage, the pivot head is movable with respect to the housing by means of a drive, which converts a linear movement into a pivot head rotation. The drive includes a linear carriage, which for inducing the movement, the linear carriage contacts at least one stop, while the housing is moved relative to this stop by the machine tool carriage and the machine tool table.

This is a Continuation-in-Part Application of pending international patent application PCT/DE2009/000429 filed Apr. 2, 2009 and claiming the priority of German Patent application 10 2008 017 117.4 filed Apr. 2, 2008.

### BACKGROUND OF THE INVENTION

The invention resides in a tool pivoting unit for the exchangeable installation in an exchange adapter of a machine tool carriage—including a pivot head which is supported in a housing and in which a rotatable tool holder is arranged wherein the pivot head is pivotable in the housing by at least 100 angular degrees about a pivot axis which is oriented transverse to the travel direction of the machine tool carriage.

DE 10 2004 062 138 133 discloses such an adjustable tool pivot unit. The tool pivot unit itself is supported on the machine carriage of a machine tool so as to be pivotable about a C-axis shaft. The housing of the tool pivot unit includes a pivot head which is pivotable about an A-axis shaft. Both shafts are driven by a single servomotor. The rotational movement of the servomotor is used via an electrically shiftable drive either for pivoting the pivot head or for the rotational movement of the machine tool pivot unit about the C-axis.

It is the object of the present invention to provide a tool pivot unit wherein at least one pivotable unit part is pivotable safely and in a simple manner without its own dedicated drive.

### SUMMARY OF THE INVENTION

In accordance with the present invention, the pivot head is movable with respect to the housing by means of a drive unit which converts a linear movement into a rotational pivot head movement. The drive unit includes a linearly moveable carriage. For an adjustment of the linear carriage, the linear carriage abuts at least one stop while the housing is moved relative to this stop by means of the tool carriage and/or the machine tool table. Alternatively, the linear carriage abuts for an adjustment at least one stop which is movable by a motor so as to be linearly adjusted thereby with respect to the stationary fixed housing.

On the other hand, with two separate pivot movements of the tool pivot unit—the housing as well as the pivot head, each is movable about its pivot axis by means of a drive. The respective drive includes a linear carriage coupled to a gear wheel or a gear segment. For adjustment, the respective linear carriage comes into contact with at least one stop while the housing is moved relative to this stop by the machine tool carriage and/or the machine tool table.

The present invention provides for a tool pivot unit, whose rotatable tool holder can be pivoted with respect to the supporting machine tool carriage about one or two pivot axes without the tool pivot unit having its own drive for executing those pivot movements. As drive for this pivot movement the machine carriages carrying the tool pivot unit are used. To this end, the respective tool pivot unit is moved for example against a stop or indexing bolt carrier fixed to the machine table in order to displace, after a first contact, for example drive parts projecting from the tool pivot unit such as a linear carriage, by a linear movement of the tool pivot unit with respect to the tool pivot unit. The respective displacement of the linear carriage is converted in the interior of the tool pivot unit into a corresponding pivot movement which is transmitted to the tool holder.

The invention will become more readily apparent from the following description of exemplary embodiments of the invention with reference to the accompanying drawings.

### BRIEF DESCRIPTION OF THE DRAWINGS

It is shown in:

FIG. 1 a tool unit with a series-connected pivot unit and a rack and pinion operating device,

FIG. 2 a tool pivot unit with a tape roller drive structure,

FIG. 3 a tape roller drive in a front view,

FIG. 4 a tape roller drive in a rear view,

FIG. 5 a tool pivot unit with a pivot disc support adjustment,

FIG. 6 the same as in FIG. 5, however with the pivot disc support coupled,

FIG. 7 the same as FIG. 6 but with pivot head 45 pivoted by 45 degrees,

FIG. 8 the same as FIG. 7 however with the pivot disc support operating structure uncoupled,

FIG. 9 a series-connected pivot unit with a tape roller drive adjustment structure,

FIG. 10 a cross-sectional view of FIG. 9, and

FIG. 11 an enlarged longitudinal sectional view of FIG. 9.

### DESCRIPTION OF PARTICULAR EMBODIMENTS

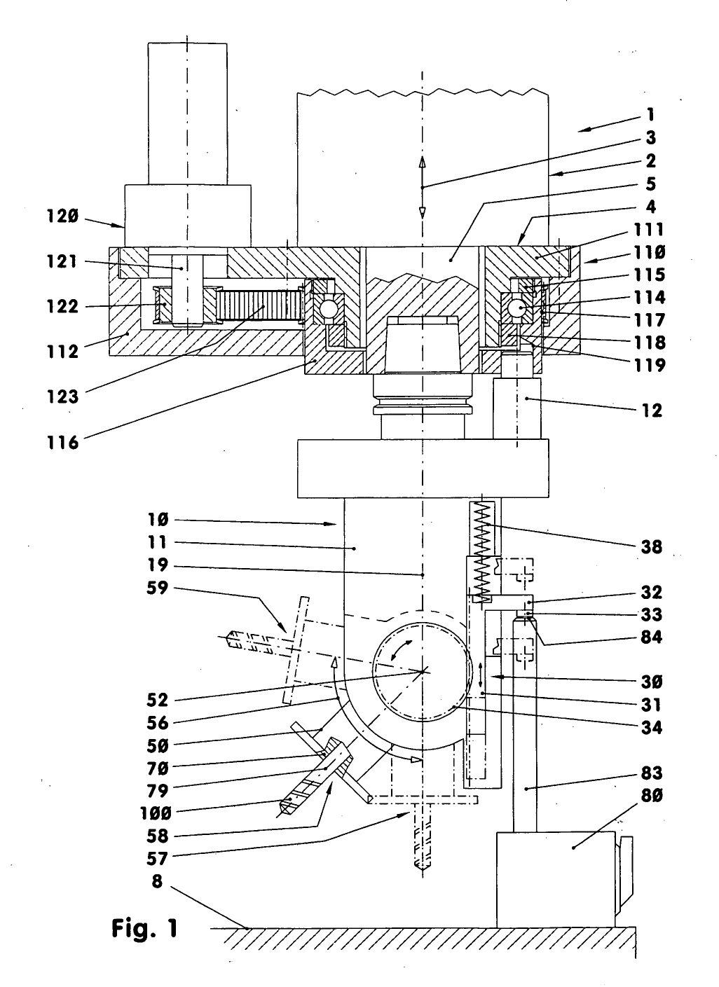

FIG. 1 shows for example a combination of a machine tool carriage 2 with a series-connected pivot unit 110, a tool pivot unit 10 and a tool 100.

The machine carriage 2 of the machine tool 1 includes an exchangeable series-connected pivot unit 110. It is coupled to the machine carriage 2 at the lower front face thereof. This front face is a part of the exchange adapter 4. From this front face, an operating spindle 5 projects for example in a vertical direction.

The operating spindle 5 is surrounded by a flange 111 on which a servo motor 120 is mounted and by which a rotatable disc 116 is supported. The rotatable disc 116 is in the form of a pot in which at least one anti-friction bearing 114 is mounted by way of its outer bearing ring using for example a shaft unit 115. To permit tightening the shaft unit 115 longitudinal slots are provided in the flange 111 which slots however are not shown in the drawings.

The inner ring of the antifriction bearing 114 is arranged on the flange 111, without play, for example by means of a shaft nut 118.

The centerline of the rotatable disc 116 extends congruent with the center line of the operating shaft 5. In the bottom wall of the rotatable disc 116 there is an off-center indexing bore 119. The outer wall of the rotatable disc 116 is provided with a toothed belt gear structure 117.

The servomotor 120 which is disposed at an outer end of the flange 111 includes a drive output shaft 121.

The servomotor 120 which is disposed at the outer end of the flange 111 has a drive output shaft 121 on which a toothed belt gear wheel 122 is firmly supported. The toothed belt gear wheel 122 is operatively connected to the tooth belt gear structure via a toothed belt 123. The belt drive is covered from below by a housing cover 112.

Below the series-connected pivot unit 110, there is a tool pivot unit 10. It includes a unit shaft 13 which is coupled to the operating shaft 5 of the machine tool 1. The housing 11 is provided with for example an upwardly projecting rigid indexing pin 12 which, after the tool pivot unit 10 has been coupled to the series-connected pivot unit 110, extends into the indexing bore 119 to prevent rotation of the flange 111. With the aid of the servomotor 120 whose rotational movement is monitored for example by a tachogenerator, the tool pivot unit 10 can be pivoted by the rotatable disc 116 with respect to the machine tool carriage 2 about the C-axis 19 by almost any desired angle.

The housing 11 of the tool pivot unit 10 supports in its lower area a pivot head 50 on which a tool holder 70, which is driven by the unit shaft 13, is supported. The pivot axis of the pivot head 50 is in this case the A-axis 52.

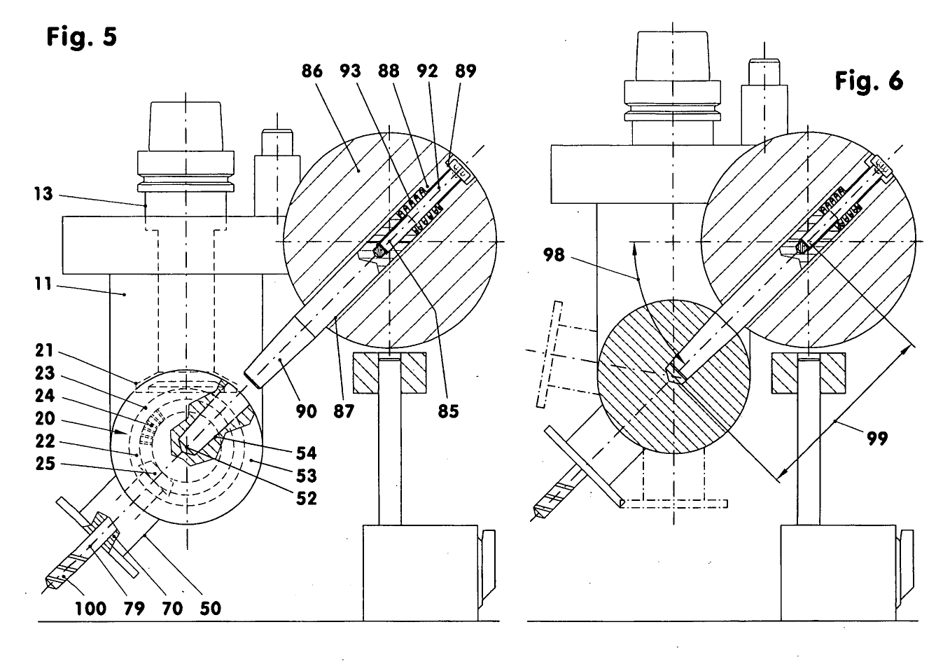

For driving the tool holder 70, the housing 11 includes a gear drive 20, see FIG. 5. It comprises for example a crown gear 21, a combi-gear 22 and a conical gear pinion 25. The crown gear 21 is disposed at the lower end of the unit shaft 13. It is in engagement with the combi-gear 22 whose center line coincides with the A-axis 52. The combi-gear 22 includes a spur gear structure 23 for engagement with the crown gear 21. At its front side which faces the centerline 19, it additionally includes a conical gear structure 24. The latter is in engagement with the conical gear pinion 25 whose center line is disposed on the center line 79 of the tool holder 70. The conical gear pinion 25 is connected to the tool holder 70 for rotation therewith. The rotation of the unit shaft 13 is transmitted, if appropriate, at increasing or decreasing speed, to the tool holder (70) and consequently to the tool 100, for example a drill, a cutter or a circular saw disc.

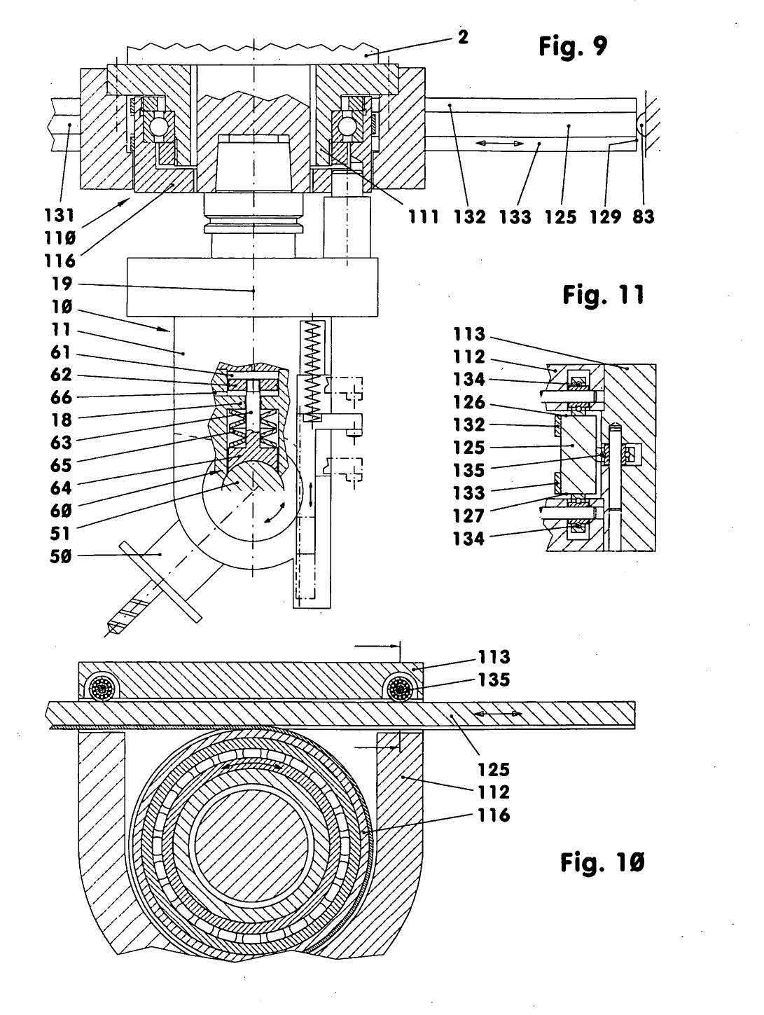

During the operation of the tool pivot unit 10, that is during drilling, cutting or sawing etc., the pivot head 50 is locked in the housing. To this end, the housing 1 includes a clamping arrangement 60, see FIG. 9. The clamping arrangement 60 comprises a brake shoe 64 which is pressed during clamping by means of a mechanical spring or a spring system against the pivot head shaft 51 or a disc-mounted thereon. For the release of the clamping for example a pneumatically operated cylinder-piston unit 61-63 is used.

In the shown exemplary embodiment, the brake shoe 64 abuts the pivot shaft 51 radially. The brake shoe 64 is provided with a rod 63 on which several for example reciprocally arranged plate openings 65 are stacked. The plate springs 65 are supported on an intermediate housing wall 18. The intermediate housing wall 18 includes a bore through which the rod 63 extends into a cylinder chamber 61. There, the rod 63 is, like a piston rod, connected to a piston 62. For releasing the brake shoe 64, pressurized air is applied to the piston rod side of the piston 62 via a compressed air line 66. As a result, the brake shoe 64 is lifted off the pivot shaft 51 at the pivot head against the force of the plate springs 65.

In order to make it possible in the exemplary embodiments to pivot the pivot head 50 for example with the operating shaft 5 at a standstill, in accordance with FIGS. 1 and 9, the pivot head shaft 51 is provided with a spur gear 34 connected to the shaft for rotation therewith. The spur gear 34 is in engagement with a gear rack 31 which, at the same time, forms a linear carriage. The shown rack and pinion drive 30 provides for a gear rack-based position adjustment.

Between the spur gear 34 and the gear rack 31 at least two gears mounted on a shaft may be interposed for transmitting the rack movement at increased or reduced speed.

The gear rack 31 extends parallel to the centerline 19. Attached thereto is a bracket 32, which projects sidewardly from the housing 11 and is provided at its free end with a downwardly facing, for example, spherically arched carriage IS stop 33. At the upper end of the gear rack, for example, a spiral compression spring 38 is disposed which is supported on the housing 11. Alternatively, the gear rack 31 may be pulled downwardly by a tension spring. It would also be possible to provide a torsion spring which is engaged by the housing and which biases the gear 34 for rotation in clockwise direction.

The geared length of the rack 31 is tuned to the maximum pivot angle 56 of the pivot head 50. The roll-off length corresponds to the length of the arc corresponding to the pivot angle 56.

In accordance with FIG. 1, a magnetic holder 80 is disposed below the tool pivot unit 10 and is attached to the machine table 8. The magnetic holder 80 includes a vertically upwardly extending stop rod 83. Instead of the magnetic holder 80, the stop rod 83 may also be engaged by other rigid support means.

In order to permit pivoting the pivot head 50 during an off period, the clamping arrangement 60 is in the housing 11 subjected to pressurized air, see FIG. 9. As a result, the brake shoe 64 is disengaged from the pivot head shaft 51. Subsequently, the pivot head 50 is pivoted by the spiral compression spring 38 clockwise into the position 59 in accordance with FIGS. 1 and 9. The downward movement of the linear carriage 31 can be achieved for example also by means of a pneumatic hydraulic, electric or electro-mechanical drive. In a pneumatic drive, the pressurized air available to the clamping arrangement 60 can also be utilized. The linear carriage 31 may also be moved downwardly under the load of a weight.

In a subsequent step, the magnet holder 80 and the tool pivot unit 10 are positioned with respect to each other in such a way that the upper front face 84 of the stop rod 83 is contacted by the carriage stop 33. The bracket 32 is then disposed in its lowest position. The pivot head 50 is now in the position 59.

Now the machine carriage 2 and the machine table 8 are moved toward one another in a CNC-controlled manner. For each selectable angular position of the pivot head 50, there is a respective stroke position of the machine carriage 2 and/or the machine table 8.

When the selected angular position has been reached the clamping arrangement 60 is depressurized, see FIG. 9. The pivot head 50 is then again locked with respect to the housing 11. The machine tool pivot unit 10 is moved away from the magnetic holder 80 or, respectively, the stop rod 83.

In order to increase the repetition accuracy of the pivot movement of the pivot head 50, the gear 34 may be in engagement at the same time with two gear racks 31 which are slidingly supported next to each other. The two gear racks 31 are then tensioned elastically relative to each other in the longitudinal direction in order to eliminate any tooth backlash. Alternatively, also two gears 34 which are rotationally tensioned relative to each other may be in engagement with a gear rack 31.

For minimizing the drive forces required for the gear rack adjustment the pivot head 50 may be provided at the side remote from the tool holder 70 with a counterweight.

In another variant, the magnetic holder 80 includes a linear drive with a measuring system having a pin which is axially adjustment under the control of the machine control unit. The pin is provided to displace the carriage 31 of the tool pivot unit 10 by changing the position of the carriage stop 33. In a particular embodiment of this variant instead of the linear drive a rotating servomotor with a tachogenerator may be used. The output shaft of the servomotor is then coupled in a special coupling cavity to a freely accessible front side of the pivot head shaft 51 of the pivot head 50 without play in order to pivot the latter as desired.

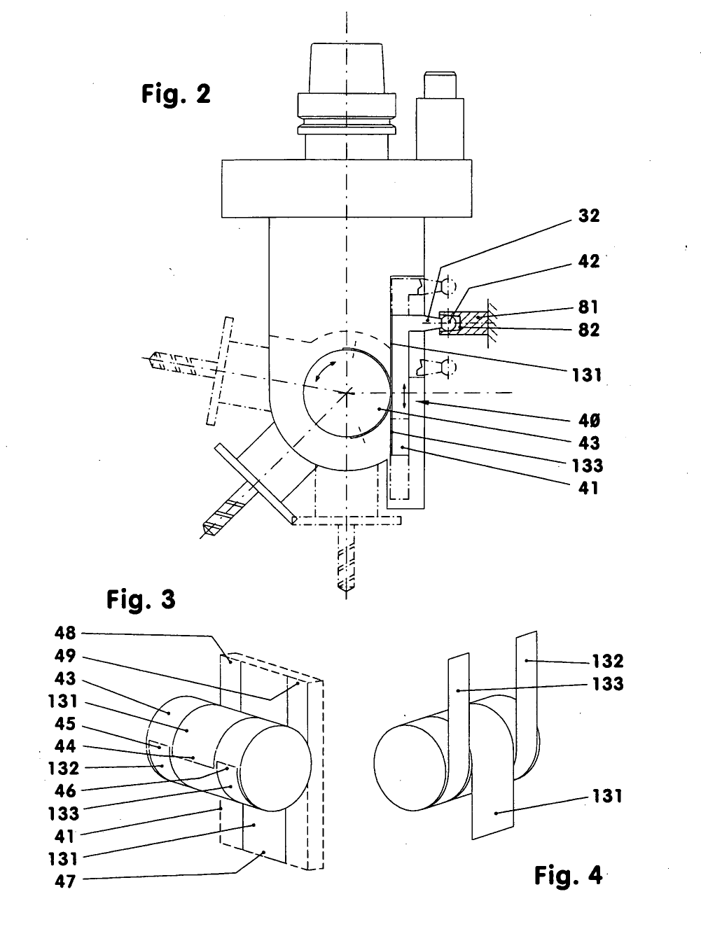

FIG. 2 shows a tool pivot unit 10 wherein, instead of the gear rack support adjustment, a roller arc support adjustment is provided. Herein the gear rack drive 30 is replaced by a roller arc drive 40.

The roller arc drive 40 consists of a linear carriage 41, for example, three metal strips 131, 132, 133 and a roller arc shaft 43, see FIGS. 3 and 4. On the roller arc shaft 4, a wide center strip 131 is attached, which extends about halfway clockwise around the roller arc shaft 43 and along the lower half of the linear carriage 41 tangentially to the roller arc shaft 43. At the lower end of the linear carriage, it is fixed to the carriage 41 at the point 47. The wrapping around the roller arc shaft 43 is shown in FIG. 4. The two outer tapes 132, 133 are attached to the roller arc shaft 43 at the points 45, 46. This tapes 132, 133 extend counter clockwise around the roller arc shaft 43 and are attached to the top of the linear carriage 41 at points 48, 49. All three tapes 131, 132, 133 are tightly tensioned to ensure play-free rolling off of the roller arc shaft. The connecting point 47 may be longitudinally adjustable in order to ensure a play free engagement.

The center tape 131 is twice as wide as one of the outer tapes 132, 133. Generally a roller arc drive requires only two tapes.

FIG. 2 shows a roller arc shaft 43 in the form of a cylindrical disc mounted on the pivot head shaft 51.

The bracket 32 of the linear carriage 41 is provided here with a ball head 42 which is engaged in for example a stationary tubular stop 81 which may be attached to a magnetic holder 80 or a stationary machine housing part. The respective mounting location is at the outer area of the operating space of the machine tool 1.

The tubular stop 81 has a conical bore 82 or a notch with correspondingly inclined planar flanks so as to provide for a play-free engagement of the ball head 42—at least in longitudinal direction of the carriage. With this embodiment of a stop, the spiral compression spring 38 shown in FIG. 1 can be omitted. However, in this case, the CNC control unit needs to remember the last angular position of the pivot head 50.

The FIGS. 5 to 8 concern a further tool pivot unit—for the exchangeable installation of an exchange adapter (4) of a machine tool carriage 2—including a pivot head 50 which is supported in a housing and in which a drivable and rotatable tool holder 70 is arranged, the pivot head 50 being pivotable in the housing 11 by at least 100 angular degrees about an axis 52 which extends transverse to movement direction of the machine tool carriage 2. The pivot head 50 is movable relative to the housing 11 by a pivot wheel 53 which includes an indexing cavity 54. For repositioning the pivot wheel 53, it is moved with its indexing cavity 54 onto an indexing bolt 90 which is supported so as to be pivotable about an indexing bolt pivot axis 85 and supported on a stationary support structure 80. The housing 11 of the machine tool unit 10 is moved by at least two machine-based carriages along a circular path 9 around the indexing bolt pivot axis 85.

Herein, during coupling, the center lines of the indexing cavity 54 and the indexing bolt 90 are disposed in a plane which in each case is oriented normal to said centerlines.

On the pivot head shaft 51, which extends at least at one side from the housing 11, the pivot wheel 53 is arranged for rotation therewith. For example, the conical indexing cavity 54 extends up to the center of the pivot wheel 53.

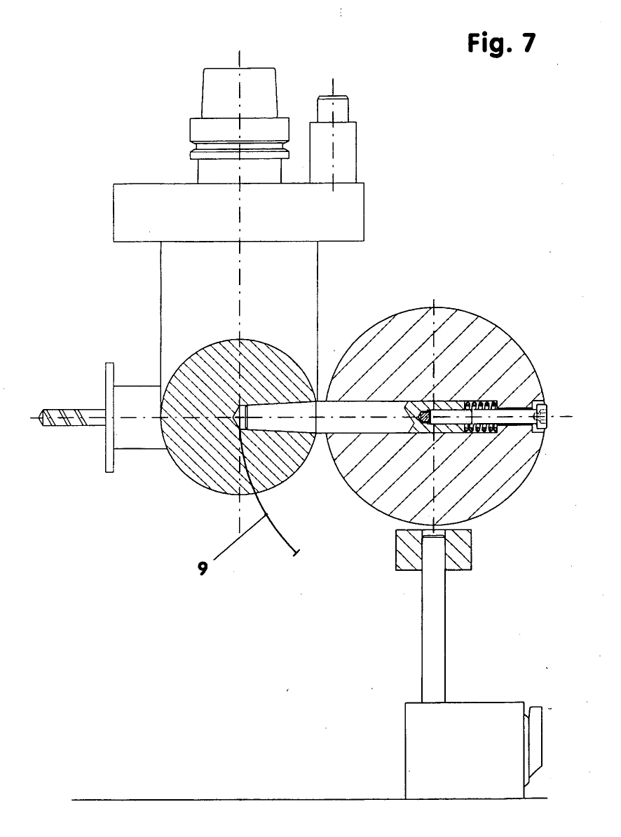

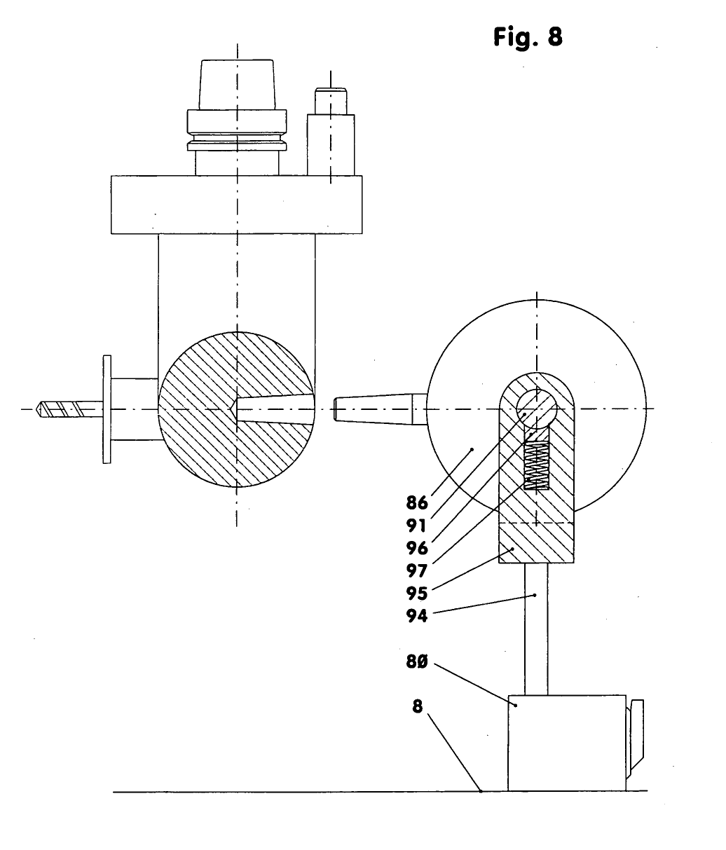

As shown in FIGS. 7 and 8, the carrier 80 is a magnetic holder which is fixed on the machine table 8 for example at the end of the operating space. On a support rod 94, a support block 95 is disposed on which for example a disc-shaped indexing bolt guide structure 86 is supported at one side thereof. The indexing bolt guide structure 86 is provided with a bearing stub 91 which is fixed to the guide structure 86 and which is supported in the bore of the support block 95 by a friction or anti-friction bearing. FIG. 8 shows a section through a bearing block-side friction arrangement. The friction arrangement consists of a friction shoe 96 and a spiral compression spring 97. The latter presses the friction shoe 96, for example, radially against the bearing stub 91. Beginning with a torque which is greater than 2 Nm the bearing stub 91 together with the indexing bolt guide structure 86 can be rotated in the support block 95.

The indexing bolt guide structure 86 in accordance with FIG. 5 includes a stepped through bore 87 in which the indexing bolt is slideably support and pretensioned. In accordance with FIG. 5, the indexing bolt 90 is supported via a spiral compression spring 93 on a bore shoulder 88 of the indexing bolt guide structure 86. The indexing bolt 90 is supported by a screw 92 which is threaded into the indexing bolt and which abuts a shoulder formed by a cylindrical cavity 89 of the through-bore 87.

As shown in FIG. 5, the tool pivot unit 10 is so positioned in front of the indexing bolt guide structure 86 that the centerlines of the indexing cavity 54 and the indexing bolt 90 are in axial alignment. The tool pivot unit 10 is moved toward the indexing bolt 90 along the centerline thereof until the indexing bolt 90 is disposed in the indexing bore 54 without play and also the A-axis 52 has a predetermined distance 99 from the indexing bolt pivot axis 85, see FIG. 6. The head of the screw 92 then no loner abuts the shoulder of the cylindrical cavity 89.

Now the tool pivot unit 10 is moved by the machine tool side carriage so along a circular path 9 that the A-axis 52 is pivoted with the fixed distance 99 about the indexing bolt pivot axis 85, see FIGS. 6 and 7. The centerline 19 of the tool pivot unit 10 is not pivoted in this process. During movement along the circular path 9 the indexing bolt 90 pivots as coupling element necessarily the pivot head 50 and the indexing bolt guide structure 86.

When the pivot head 50 has reached a predetermined pivot angle, the tool pivot unit 10 is moved away from the indexing bolt guide structure 86, see FIG. 8. Up to the next pivoting of the pivot head 50, the indexing bolt guide structure 86 remains in the position shown. The CNC control unit remembers the location and the angular position of the indexing bolt 90.

The FIG. 9 to 11 show a tool pivot unit 10 with a series-connected pivot unit 110 without drive. Herein, the rotatable disc 116 shown in FIG. 1 is provided with a roller arc drive as depicted in FIGS. 3 and 4. In this case, however, the rotatable disc 116 which is in the form of a roller arc shaft around which tapes (131, 132, 133) extend, is pivotable around about 200 to 360 angular degrees. The tapes (131-133) consist for example of metal.

The linear carriage 125 is supported in a friction free manner in for example a two-part housing cover (112, 113). As shown in FIGS. 10 and 11, the narrow longitudinal sides (126, 127) of the linear carriage 125 are supported each by two anti-friction bearings 134. The side support is provided by two antifriction bearings 135 which are arranged in the smaller housing cover side parts 113. Between them and the rotatable disc 116, the linear carriage 125 is engaged in a plane extending transverse to the center line 19.

For pivoting the rotatable disc 116 with respect to the flange 111, the series-connected pivot unit 110 is moved for example by the machine tool carriage 2 in the longitudinal direction rection of the linear carriage 125. At the end of the machine side operating chamber, the respective, for example planar, front face 129 of the linear carriage 125 comes into contact with for example a spherical stop 83 which is arranged stationarily opposite the series-connected pivot unit 110. Since the series-connected pivot unit 110 moves toward the stop 83 the linear carriage 125 rolls off the rotatable disc 116 via the tapes (131-133). The rotatable disc 116 in this way pivots the machine tool pivot unit in a predetermined manner.

In order to reverse the pivot movement the machine tool carriage 2 is moved in the opposite direction while rolling along the rotatable disc 116 held in engagement with the disc by the tapes. At the opposite end of the separating chamber, the linear carriage 125 abuts another stop.

Instead of the roller arc drive also in this case a gear rack drive may be used. Also, a pivot disc support drive adjustment device as shown in FIGS. 5-8 is possible.

The linear carriage 125 as shown in FIGS. 9 and 11 is shortened.

### LISTING OF REFERENCE NUMERALS

| | |
|---|---|
| 1 | Machine tool |
| 2 | Machine tool carriage |
| 3 | Travel direction |
| 4 | Exchange adapter |
| 5 | Operating shaft |
| 8 | Machine table |
| 9 | Circular path, flat |
| 10 | Tool pivot unit |
| 11 | Housing |
| 12 | Indexing pin |
| 13 | Unit shaft |
| 18 | Intermediate housing wall |
| 19 | Centerline, C-axis |
| 20 | Gear drive |
| 21 | Spur gear |
| 22 | Combination gear |
| 23 | Spur gearing |
| 24 | Conical gear structure |
| 25 | Conical gear pinion |
| 30 | Rack and pinion drive |
| 31 | Gear rack, linear carriage |
| 32 | Bracket |
| 33 | Carriage stop |
| 34 | Spur gear, gear segment |
| 38 | Compression spring |
| 40 | Drive, roller arc drive |
| 41 | Linear carriage |
| 42 | Ball head |
| 43 | Roller arc shaft, -segment, -gear |
| 44, 45, 46 | Connecting parts to (43) |
| 47, 48, 49 | Connecting parts to (41) |
| 50 | Pivot head, unit part |
| 51 | Pivot head shaft |
| 52 | A-axis, center line |
| 53 | Pivot wheel |
| 54 | Indexing cavity |
| 56 | Pivot angle |
| 57 | Extended position |
| 58 | Position at 45° pivot angle |
| 59 | Position during greatest pivot angle |
| 60 | Clamping arrangement |
| 61 | Cylinder chamber |
| 62 | Piston |
| 63 | Connecting rod |
| 64 | Brake shoe |
| 65 | Plate spring |
| 66 | Compressed air line |
| 70 | Tool holder |
| 79 | Centerline |
| 80 | Magnetic holder, stationary support |
| 81 | Tubular stop, two-sided |
| 82 | Conical bore, notch |
| 83 | Stop, stop rod |
| 84 | Front face, top |
| 85 | Indexing bolt pivot axis |
| 86 | Indexing bolt guide structure |
| 87 | Through-bore |
| 88 | Bore shoulder |
| 89 | Cylinder cavity |
| 90 | Indexing bolt |
| 91 | Bearing stub |
| 92 | Screw |
| 93 | Spiral compression spring |
| 94 | Support rod |
| 95 | Support block |
| 96 | Friction shoe |
| 97 | Spiral compression spring |
| 98 | Pivot angle |
| 99 | Distance, radius |
| 100 | Tool |
| 110 | Series-connected pivot unit |
| 111 | Flange |
| 112 | Housing cover |
| 113 | Housing cover side part |
| 114 | Anti-friction bearing |
| 115 | Shaft unit |
| 116 | Rotatable disc |
| 117 | Toothed belt gear structure |
| 118 | Shaft unit |
| 119 | Indexing bore |
| 120 | Servomotor |
| 121 | Drive output shaft |
| 122 | Toothed belt gear wheel |
| 123 | Toothed belt |
| 125 | Linear carriage |
| 126, 127 | Narrow longitudinal sides |
| 129 | Front faces |
| 131, 132, 133 | Tapes, center, outer, outer |
| 134 | Antifriction bearing horizontal |
| 135 | Antifriction bearing side guide |

What is claimed is:

1. A tool pivot unit for the replaceable installation in an exchange adapter (4) of a movable machine tool carriage (2) including a pivot head (50) supported in a housing (11) in which a rotatable tool holder (70) is operably arranged, the pivot head (50) being supported in the housing (11) so as to be pivotable by at least 100 angular degrees about a pivot axis (52) which extends transverse to the direction of travel (3) of the machine tool carriage (2),
the pivot head (50) being movable relative to the housing (11) by means of a drive (30, 40) which converts a linear movement into a pivot head rotation,
the drive (30, 40) including a linear carriage (31, 41), and,
for a displacement of the linear carriage (31, 41) relative to the housing (11) the linear carriage (31, 41) upon placement thereof into contact with at least one stop (83, 81), being held stationary by said stop while the housing (11) is moved relative to this stop (83, 81) by means of one of one of the machine tool carriage (2) and the machine tool table 8, or
the linear carriage (31, 41) comes into contact with a stop which is movable by a motor for moving the linear carriage linearly with respect to the stationary housing (11).

2. The tool pivot unit according to claim 1, wherein the pivot unit includes a vertically oriented unit shaft (13) which is connectable to an operating shaft (5) of the machine tool (1) for rotation with the operating shaft (5).

3. The tool pivot unit according to claim 1, wherein
the pivot range of the pivot head (50) includes a position (51) in which the centerline (79) of the tool holder (70) is in axial alignment with the centerline (19) of the unit shaft (13).

4. The tool pivot unit according to claim 1, wherein on the shaft (51) of the pivot head (50) a gear wheel (34, 43) is disposed which is operatively connected to the linear carriage (31, 41), wherein a certain travel distance of the linear carriage (31, 41) corresponds to a certain pivot angle of the gear wheel (34, 43).

5. The tool pivot unit according to claim 1, wherein the pivot head (50) is lockable in the housing (11) by means of a mechanical clamping arrangement (60), the clamping arrangement (60) being releasable by means of one of a pneumatic, hydraulic, electric, electromechanical and piezoelectric drive (61, 63) to permit pivoting the pivot head (50).

6. The tool pivot unit according to claim 1, wherein, the linear carriage (31, 41) after the release of the clamping arrangement (60), is moved downwardly under the effect at least of a spring element (38), the effect of gravity or the effect of one of a pneumatic, hydraulic, electric or electromechanical drive.

7. The tool pivot unit according to claim 1, wherein the stop (83, 81) is arranged in the end area of the operating space of the machine tool (1).

8. The tool pivot unit according to claim 1, wherein the stop (83, 81) is arranged on a magnetic holder (80) on the machine tool housing and the machine tool table (8).

9. A machine tool pivot unit for the replaceable installation in an exchange adapter (4) of a machine tool carriage (21) provided with an operating shaft (5), including a housing (11) which is pivotable with respect to the machine tool carriage (2) about the centerline (19) of the operating shaft (5), a pivot head (50) which is supported in the housing (11) and in which a drivable and rotatable tool holder (70) is arranged, the pivot head (50) being pivotable in the housing (11) by at least (100) angular degrees about an axis (52) which extends transverse to the centerline (19) of the operating shaft (5),
the housing (11) as well as the pivot head (50) is movable about the respective pivot axis (19, 52) by means of a drive (30, 40),
which includes a linear carriage (31, 41) which is force-coupled to a drive wheel, and,
for adjustment of the respective linear carriage (31, 41) it is in contact with at least one stop (83, 81) while the housing (11) is moved relative to this stop (83, 81) by means of one of the machine tool carriage (2) and the machine tool table (8).
